(19) United States
(12) Patent Application Publication
(10) Pub. No.: US 2007/0182375 A1
(43) Pub. Date: Aug. 9, 2007

(54) Battery charger and method for charging a battery

(76) Inventor: Won-Woo Lee, Seoul (KR)

Correspondence Address: LAW OFFICE OF MONICA H CHOI, P O BOX 3424, DUBLIN, OH, 430160204, US

(21) Appl. No.: 11/698,696

(22) Filed: Jan. 26, 2007

(30) Foreign Application Priority Data
Feb. 2, 2006 (KR) 2006-09991

(51) Int. Cl. H02J 7/00

(52) U.S. Cl. 320/130

(57) ABSTRACT

A battery charger includes current sources for generating first and second currents respectively, a current sensor, a current source controller, and a reference voltage generator. The first current charges a battery in a first current path, and the second current is conducted to a feedback load in a second current path separate from the first current path. The current sources form a current mirror and are controlled by the current source controller from comparing a reference voltage with a terminal voltage of the feedback load. The current sensor indicates a level of the first current to the reference voltage generator that sets the reference voltage such that the first current is maintained to be constant.

This application claims priority to Korean Patent Application No. 2006-09991, filed on Feb. 2, 2006 in the Korean Intellectual Property Office, the disclosure of which is incorporated herein in its entirety by reference.

### BACKGROUND OF THE INVENTION

1. Field of the Invention

The present invention relates generally to battery technology, and more particularly to charging a battery with constant charging current and with a terminal voltage of the battery limited to a maximum regulation voltage.

2. Background of the Invention

Mobile apparatuses such as notebooks, digital camcorders, digital cameras, cell phones, etc. are being increasingly used. A power source system included in a mobile apparatus uses a battery for stably providing the mobile apparatus with power. Some batteries for the power source system of the mobile apparatus are recharged by a charger, and such batteries are referred to as a secondary battery.

A battery charger is desired to charge a battery with a charge current having a constant level during a constant current charge mode. Such a charge current is also desired to have a level that is precisely controlled. In that case, the time required for charging the battery may be more exactly predicted for a user.

FIG. 1 is a block diagram of a conventional constant current charge circuit in a battery charger. Referring to FIG. 1, the constant current charge circuit includes a constant current circuit 1, a current detection circuit 2, and a current control circuit 3. The constant current circuit 1 has a BJT (bipolar junction transistor) 11 and a first resistor 12. The current detection circuit 2 has a second resistor 21. The current control circuit 3 has analog-to-digital converters (ADCs) 31 and 32, a digital-to-analog converter (DAC) 33, and a central processing unit (CPU).

The second resistor 21 measures a level of the charge current, and the current control circuit 3 adjusts a voltage at the base of the BJT 11 for maintaining the charge current flowing through the BJT 11. Such a constant current charger of the prior art unfortunately does not limit the charge voltage of the battery and thus may not prevent the battery from being overcharged.

Additionally, an output current of the BJT 11 may be greatly changed even with a very small change of the base voltage, and the BJT 11 is highly sensitive to temperature. Thus, the conventional constant current charge circuit of FIG. 1 does not provide a charge current that may be precisely controlled and may not provide a stable charge current.

### SUMMARY OF THE INVENTION

A battery charger according to an aspect of the present invention includes first and second current sources, a current sensor, a current source controller, and a reference voltage generator. The first current source generates a first current for charging a battery in a first current path, and the second current source generates a second current conducted to a feedback load in a second current path. The first and second current paths are separate with the first and second current sources forming a current mirror. The current sensor indicates a level of the first current. The current source controller adjusts the first and second currents by comparing a reference voltage with a terminal voltage of the feedback load. The reference voltage generator sets the reference voltage depending on the level of the first current such that the first current is maintained to be constant.

In one embodiment of the present invention, the current sensor includes a resistor and an amplifier. The resistor has a measured current flowing there-through, and the amplifier amplifies a voltage across the resistor for generating an output signal that indicates the level of the first current.

The measured current is a sum of the first and second currents in one embodiment of the present invention. Alternatively, the measured current is one of the first current or the second current.

In another embodiment of the present invention, the reference voltage generator sets the reference voltage from comparing the output signal with a target value. For example, the reference voltage generator includes an analog-to-digital converter (ADC), a digital controller, and a digital-to-analog converter (DAC). The ADC converts the output signal to a digital output signal. The digital controller generates a digital reference voltage by comparing the digital output signal with the target value. The DAC converts the digital reference voltage to the analog reference voltage.

In an example embodiment of the present invention, the digital controller includes a first register for storing the target value and includes a second register for storing the digital reference voltage. The digital controller also includes a comparator for comparing the digital output signal with the target value, and includes a register updater for updating the digital reference voltage in accordance with the comparison of the digital output signal and the target value.

In a further embodiment of the present invention, the register updater reduces the digital reference voltage when the digital output signal is higher than the target value, raises the digital reference voltage when the digital output signal is lower than the target value, and maintains the digital reference voltage when the digital output signal is substantially the same as the target value.

In another example embodiment of the present invention, the reference voltage generator includes a first register for storing the target value and includes a second register for storing the digital reference voltage. The reference voltage generator also includes a DAC (digital-to-analog converter) for converting the target value to an analog target value, and includes a comparator for comparing the output signal with the analog target value. The reference voltage generator further includes an ADC (analog-to-digital converter) for digitizing the comparison result of the output signal and the analog target value, and includes a register updater for updating the digital reference voltage in accordance with the digitized comparison result. The reference voltage generator additionally includes another DAC (digital-to-analog converter) for converting the digital reference voltage in the second register to the analog reference voltage.

In another aspect of the present invention, the battery charger further includes a charge voltage regulator for limiting a battery terminal voltage to a maximum regulation voltage.

In an example embodiment of the present invention, the charge voltage regulator includes a voltage level detector for detecting the battery terminal voltage, and includes a third current source for generating a third current flowing to the feedback load depending on the battery terminal voltage. In that case, the third current source generates the third current that increases in proportion to the battery terminal voltage when the battery terminal voltage is greater than or equal to the lower regulation voltage such that the battery terminal voltage is limited to the maximum regulation voltage.

In this manner, the charge current for charging the battery is precisely controlled and is maintained at the desired level. In addition, the battery terminal voltage is limited to the maximum regulation voltage such that the battery is not overcharged.

### BRIEF DESCRIPTION OF THE DRAWINGS

The above and other features and advantages of the present invention will become more apparent when described in detailed exemplary embodiments thereof with reference to the attached drawings in which:

FIG. 1 is a block diagram of a conventional constant current charge circuit;

FIG. 2 is a block diagram of a first battery charger according to an example embodiment of the present invention;

FIG. 3 is a block diagram of a second battery charger according to another example embodiment of the present invention;

FIG. 4 is a block diagram of a third battery charger according to a further example embodiment of the present invention;

FIG. 5 is a circuit diagram of a first current sensor in FIG. 2, according to an example embodiment of the present invention;

FIG. 6 is a block diagram of a reference voltage generator in FIG. 2 according to an example embodiment of the present invention;

FIG. 7 is a block diagram of a digital controller in FIG. 6 according to an example embodiment of the present invention;

FIG. 8 is a block diagram of a reference voltage generator in FIG. 2 according to another example embodiment of the present invention; and

FIG. 9 shows a timing diagram of signals during operation of the battery charger of FIG. 2 according to an example embodiment of the present invention.

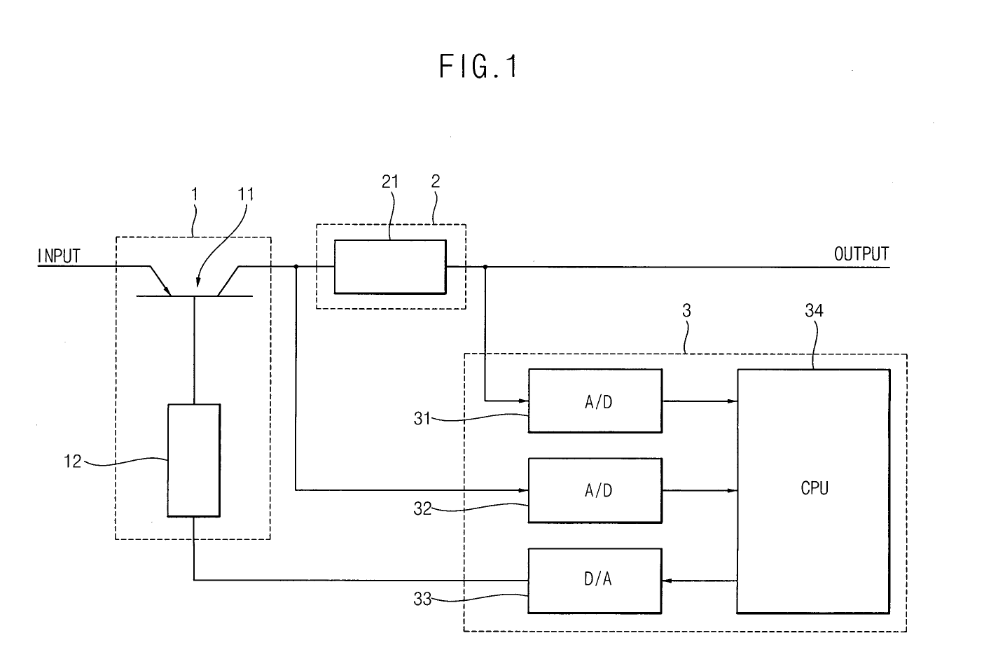

The figures referred to herein are drawn for clarity of illustration and are not necessarily drawn to scale. Elements having the same reference number in FIGS. 1, 2, 3, 4, 5, 6, 7, 8, and 9 refer to elements having similar structure and/or function.

### DETAILED DESCRIPTION OF THE INVENTION

Embodiments of the present invention now will be described more fully with reference to the accompanying drawings. The present invention may, however, be embodied in many different forms and should not be construed as limited to the example embodiments set forth herein. Rather, these embodiments are provided so that this disclosure will be thorough and complete, and will fully convey the scope of the invention to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

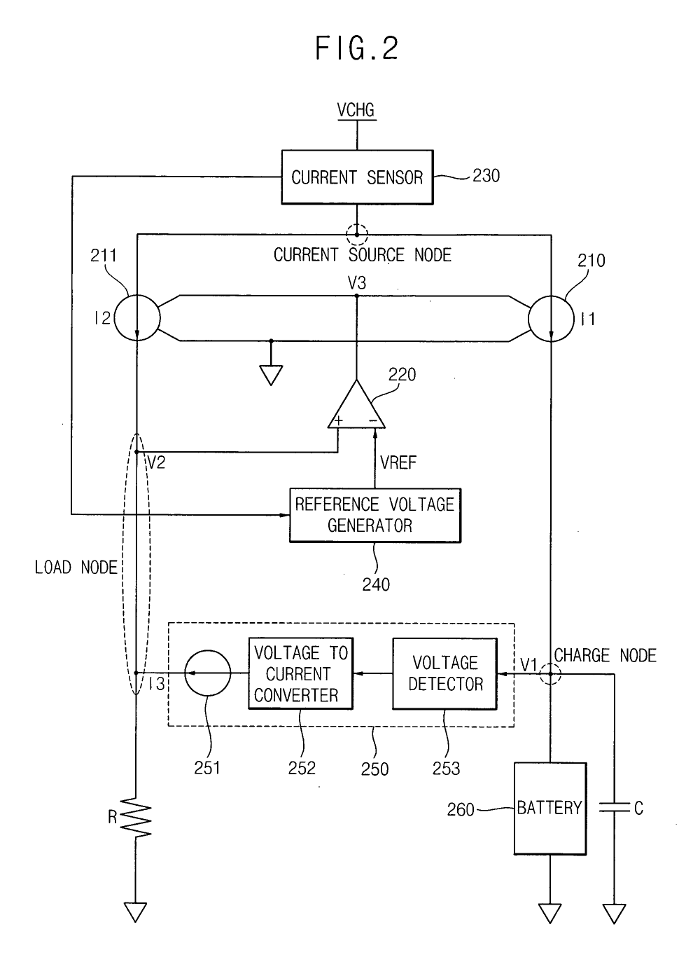

FIG. 2 is a block diagram of a first battery charger according to an example embodiment of the present invention. Referring to FIG. 2, the first battery charger includes a first current source 210, a second current source 211, a current source controller 220, a first current sensor 230, and a reference voltage generator 240. The first battery charger further includes a charge voltage regulator 250 that limits a charge voltage (i.e., a battery terminal voltage V1) of a battery 260 to a maximum regulation voltage (Vreg2 in FIG. 6).

The current source controller 220 controls the magnitude of a first current I1 generated by the first current source 210 and the magnitude of a second current I2 generated by the second current source 211. The first and second current sources 210 and 211 are configured as a current mirror such that the first and second currents I1 and I2 are substantially same. The reference voltage generator 240 generates a reference voltage Vref from an output signal of the first current sensor 230.

The first current source 210 generates the first current I1, i.e., a charge current, supplied to the battery 260 in a first current path. The second current source 211 generates the second current I2 supplied to a feedback load R in a second current path. The first and second current paths of the first and second current sources I1 and I2 are separate current paths according to an aspect of the present invention.

The second current source 211, the feedback load R, and the current source controller 220 form a negative feed-back loop that maintains the charge current I1 to a constant level as now described. The current source controller 220 compares a load terminal voltage V2 of the feedback load R, with the reference voltage Vref. The first and second current sources 210 and 211 are voltage controlled current sources. Thus, the respective magnitude of each of the first and second currents I1 and I2 is set in accordance with an output voltage V3 of the current source controller 220.

In one example embodiment of the present invention, when the output voltage V3 of the current source controller 220 increases, the first and second currents I1 and I2 each decrease. When the second current I2 increases, the load terminal voltage V2 increases. When the reference voltage Vref is constant, the increased load terminal voltage V2 increases the output voltage V3 which in turn decreases the first and second currents I1 and I2.

Alternatively, when the second current I2 decreases, the load terminal voltage V2 decreases. When the reference voltage Vref is constant, the decreased load terminal voltage V2 decreases the output voltage V3 which in turn increases the first and second currents I1 and I2. In this manner, the first and second current I1 and I2 are each maintained with negative feed-back to a constant level in a constant current charge mode.

The present invention may be practiced with other configurations of the first and second current sources 210 and 211 and the current source controller 220 in the negative feedback loop. For example, the increased output voltage V3 may increase the first and second currents I1 and I2. In that case, the reference voltage Vref is applied at the positive input of the current source controller 220, and the load terminal voltage V2 is applied at the negative input of the current source controller 220.

Also in that case, when the second current I2 increases, the load terminal voltage V2 increases. When the reference voltage Vref is constant, the increased load terminal voltage V2 decreases the output voltage V3 which in turn decreases the first and second currents I1 and I2. Alternatively, when the second current I2 decreases, the load terminal voltage V2 decreases. When the reference voltage Vref is constant, the decreased load terminal voltage V2 increases the output voltage V3 which in turn increases the first and second currents I1 and I2. Thus, the first and second current I1 and I2 are each maintained with negative feed-back to a constant level in the constant current charge mode.

However, the charge current I1 may change from various factors such as temperature variation for example. In that case, the present invention adjusts the reference voltage Vref for maintaining the charge current I1 to be constant. The first current sensor 230 is coupled between a high power voltage supply VCHG and the first and second current sources 201 and 211 for sensing a sum current of the first and second currents I1 and I2 at a current source node.

Such a sum current indicates the level of the charge current I1. For example, when the current mirror formed by the first and second current sources 210 and 211 has a current ratio of 1:1, the sum current is twice that of the charge current I1. Thus, the level of the charge current I1 may be determined by sensing the sum current.

The first current sensor 230 generates the output voltage V3 indicating the level of the charge current I1. The output voltage V3 is used by the reference voltage generator 240 that generates the reference voltage Vref depending on the output voltage V3. Embodiments of the first current sensor 230 and the reference voltage generator 240 are described in more detail later herein.

The operation of the charge voltage regulator 250 for limiting the battery terminal voltage V1 at the battery 260 to the maximum regulation voltage (Vreg2 in FIG. 6) in a constant voltage charge mode is now described. The battery terminal voltage V1 increases as the charge current I1 flows to the battery 260 in the constant current charge mode.

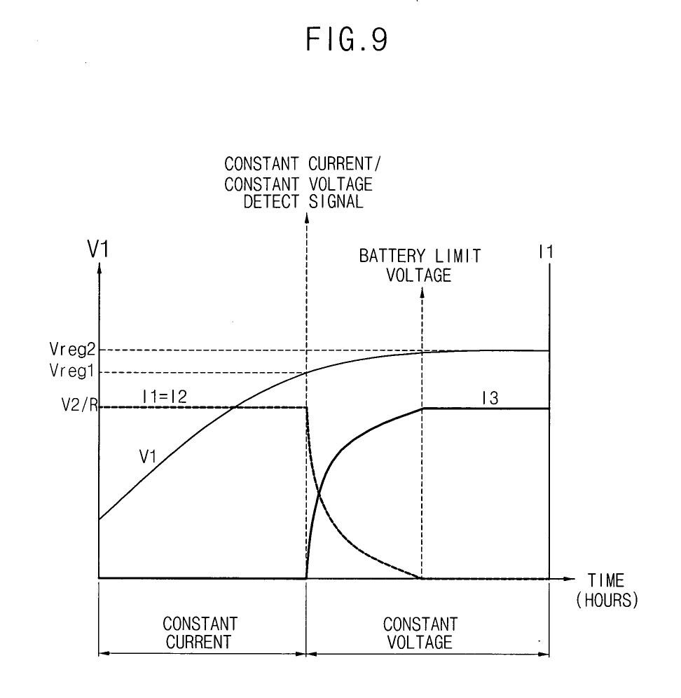

A voltage level detector 253 detects the battery terminal voltage V1. When the battery terminal voltage V1 reaches a lower regulation voltage (Vreg1 in FIG. 9), a voltage-to-current converter 252 converts the battery terminal voltage V1 to a third current I3 that is also supplied to the feedback load R. In addition, the third current I3 increases in proportion to any increase of the battery terminal voltage V1 that is higher than the lower regulation voltage.

In the constant voltage charge mode after the battery terminal voltage V1 has reached the lower regulation voltage, the reference voltage generator 240 is deactivated to just maintain the reference voltage Vref at the level when the battery terminal voltage V1 reached the lower regulation voltage.

In that case, the load terminal voltage V2 also has a constant level expressed as follows by Equation 1 with the second and third currents I1 and I3 flowing to the feedback load R:

V2=(I2+I3)×R [Equation 1]

When the battery terminal voltage V1 increases, the charge voltage regulator 250 increases the third current I3 for decreasing the second current I2 which in turn decrease the charge current I1. In this manner, when the battery terminal voltage V1 reaches the maximum regulation voltage, the first current I1 becomes zero such that the battery terminal voltage V1 is limited to the maximum regulation voltage.

On the other hand, if the battery terminal voltage V1 decreases due to discharge of the battery 260, the battery terminal voltage V1 decreases such that the third current I3 decreases. The decreased third current I3 increases the second current I2, and the first current I1 increases such that the battery terminal voltage V1 increases back toward the maximum regulation voltage. In this manner, the battery terminal voltage V1 is maintained at the maximum regulation voltage during the constant voltage charge mode.

The present invention may also be practiced when a current sensor is disposed at different nodes aside from the example of FIG. 2.

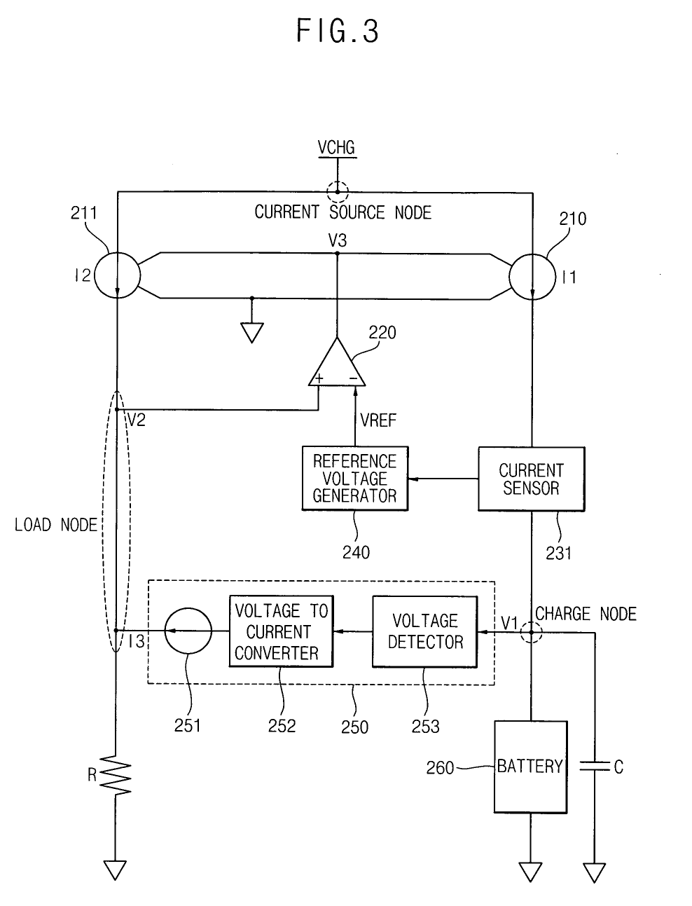

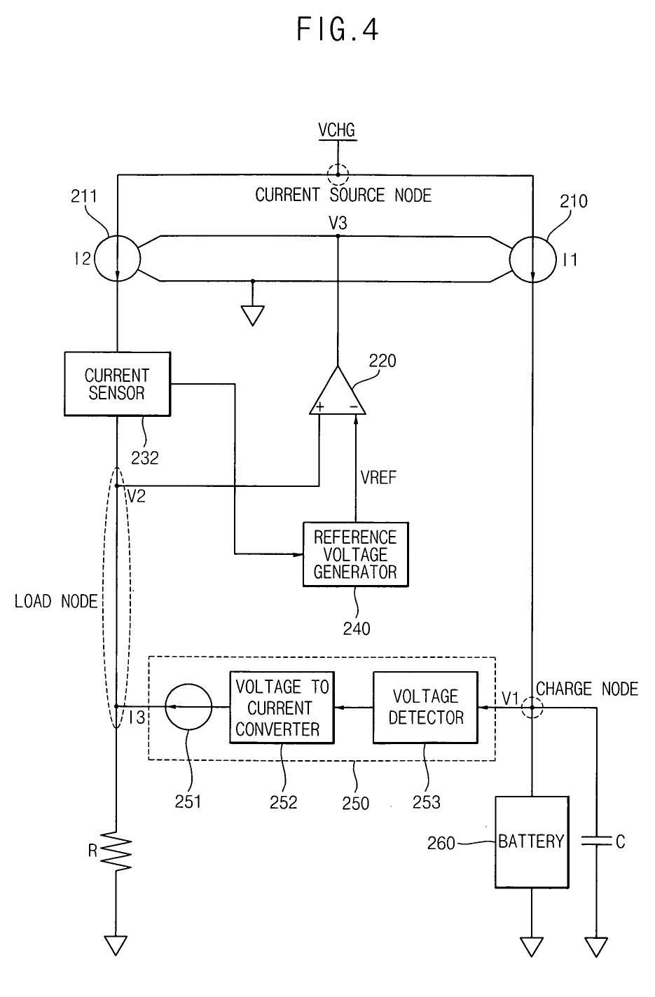

FIG. 3 is a block diagram of a second battery charger in accordance with another example embodiment of the present invention. FIG. 4 is a block diagram of a third battery charger in accordance with a further example embodiment of the present invention. Elements having the same reference number in FIGS. 2, 3, and 4 refer to elements having similar structure and/or function, and a detailed description of such elements in FIGS. 3 and 4 are not repeated.

Referring to FIGS. 2 and 3, a second current sensor 231 in FIG. 3 is disposed between the first current source 210 and the charge node of the battery 260. In that case, the second current sensor 231 directly senses the first current I1 for the reference voltage generator 240. Referring to FIGS. 2 and 4, a third current sensor 232 in FIG. 4 is disposed between the second current source 211 and the load node of the feedback load R. In that case, the third current sensor 232 indirectly senses the first current I1 by sensing the second current I2 for the reference voltage generator 240.

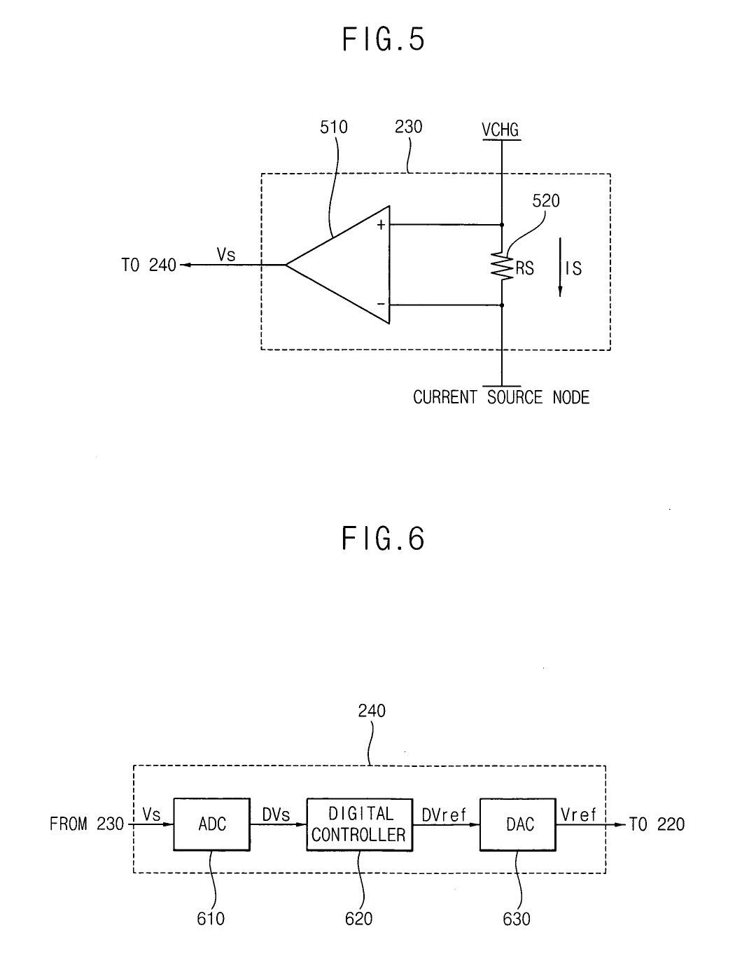

FIG. 5 is a circuit diagram of the first current sensor 230 in FIG. 2. The second current sensor 231 of FIG. 3 and the third current sensor 232 may also be implemented in a similar manner.

Referring to FIG. 5, the first current sensor 230 includes an amplifier 510 and a resistor 520. The resistor 520 has a measured current flowing there-through. For the first current sensor 230 in FIG. 2, such a measured current is the sum of the first and second currents I1 and I2. For the second current sensor 231 in FIG. 3, such a measured current is the first current I1. For the third current sensor 232 in FIG. 4, such a measured current is the second current I2.

The amplifier 510 amplifies a voltage across the terminals of the resistor 520 to generate the output voltage Vs for the reference voltage generator 240. The present invention may also be practiced when the current sensor 230 is implemented with a transconductor instead of the amplifier 510. In that case, the transconductor converts the voltage across the terminals of the resistor 520 to generate an output current.

FIG. 6 is a block diagram of the reference voltage generator 240 according to an example embodiment of the present invention. Referring to FIG. 6, the reference voltage generator 240 includes a first analog-to-digital converter (ADC) 610, a digital controller 620, and a first digital-to-analog converter (DAC) 630. The first ADC 610 receives the output voltage Vs from the current sensor 230 (see FIG. 5), and converts the output voltage Vs to a digital output voltage DVs.

The digital controller 620 compares the digital output voltage DVs with a digital target voltage to generate a digital reference voltage DVref. The first DAC 630 converts the digital reference voltage DVref to an analog reference voltage Vref that is provided to the current source controller 220.

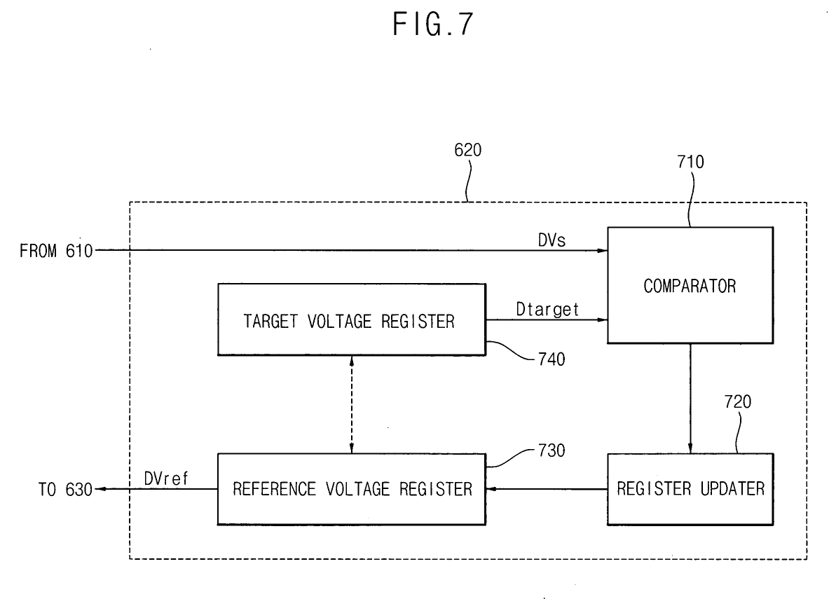

FIG. 7 is a block diagram of the digital controller 620 of FIG. 6 according to an example embodiment of the present invention. Referring to FIG. 7, the digital controller 620 includes a first comparator 710, a first register updater 720, a first reference voltage register 730, and a target voltage register 740.

The first reference voltage register 730 stores the digital reference voltage DVref. The target voltage register 740 stores a digital target voltage Dtarget. The first comparator 710 compares the digital output voltage DVs with the digital target voltage Dtarget. The first register updater 720 updates the digital reference voltage DVref in accordance with the comparison result of the digital output voltage DVs and the digital target voltage Dtarget.

The digital target voltage Dtarget is the desired digital output voltage DVs. An initial value of the digital reference voltage DVref is set in the first reference voltage register 730. The digital controller 620 may be configured so that the first reference voltage register 730 is automatically reset to the initial value of the digital reference voltage DVref when the digital target voltage Dtarget is set in the target voltage register 740.

Alternatively, the digital controller 620 may be configured so that the target voltage register 740 is automatically set to the digital target voltage Dtarget when the initial value of the digital reference voltage DVref is set in the first reference voltage register 730. Alternatively, the digital controller 620 may be configured so that the setting of the digital target voltage Dtarget in the target voltage register 740 and the setting of the initial value of the digital reference voltage DVref in the first reference voltage register 730 are independently performed. Once the digital target voltage Dtarget has been set, the digital target voltage Dtarget is not changed before being reset. However, the digital reference voltage DVref may be changed by the register updater 720.

Thus, when power is applied to the battery charger after the battery charger has been off, the digital reference voltage DVref is adjusted until the charge current I1 reaches a predetermined desired value. Additionally, when the charge current I1 reaches the predetermined desired value, the digital reference voltage DVref may be changed to prevent the charge current I1 from being changed.

The first comparator 710 provides the first register updater 720 with a result of comparison of the digital output voltage DVs with the digital target voltage Dtarget. The first register updater 720 reduces the digital reference voltage DVref by one incremental step when the digital output voltage DVs is higher than the digital target voltage Dtarget. Alternatively, the first register updater 720 raises the digital reference voltage DVref by one incremental step when the digital target voltage Dtarget is higher than the digital output voltage DVs. Further, the first register updater 720 maintains the reference voltage DVref when the digital output voltage DVs is substantially the same as the digital target voltage Dtarget. The digital reference voltage DVref is provided to the first DAC 630.

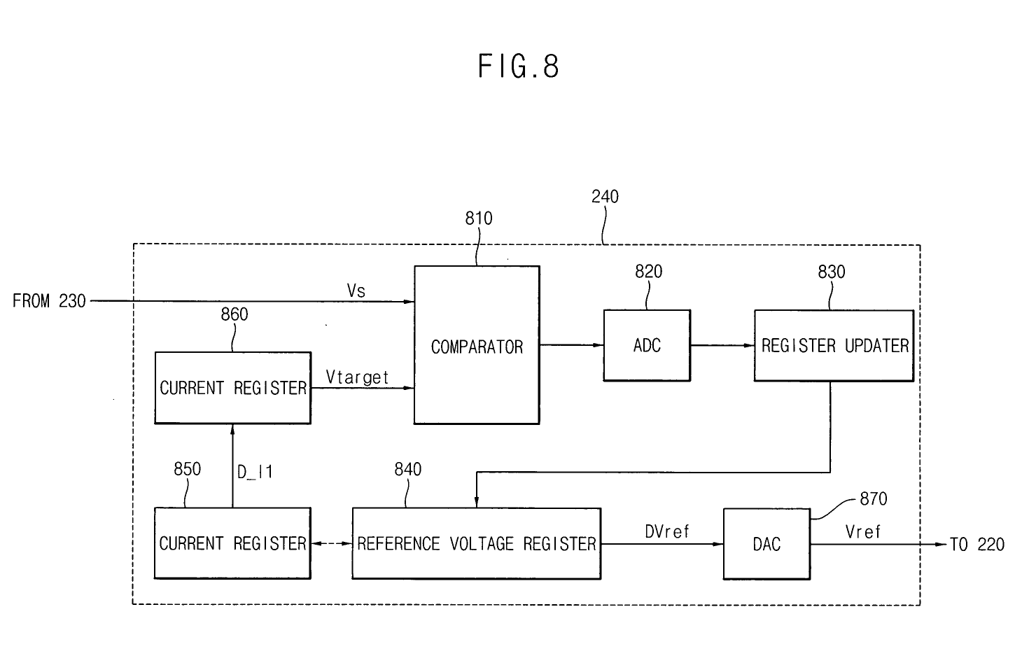

FIG. 8 is a block diagram of the reference voltage generator in FIG. 2 according to another example embodiment of the present invention. Referring to FIG. 8, the reference voltage generator 240 includes a second comparator 810, a second ADC 820, a second register updater 830, a second reference voltage register 840, a current register 850, a second DAC 860, and a third DAC 870.

The second reference voltage register 840 stores the digital reference voltage DVref. The current register 850 stores a target first current D_I1 which is the desired level of the charge current I1. The second DAC 860 converts the target charge current D_I1 to an analog target voltage Vtarget. The second comparator 810 compares the target voltage Vtarget with the output voltage Vs of the current sensor 230.

The second ADC 820 converts the result of the comparison of the target voltage Vtarget and the output voltage Vs of the current sensor 230 to a digital signal. The second register updater 830 updates the digital reference voltage DVref in accordance with the digitized comparison result from the second ADC 820. The third DAC 870 converts the digital reference voltage DVref to the analog reference voltage Vref.

The target charge current D_I1 that is a digital value is set in the current register 850. An initial value of the digital reference voltage DVref is set in the second reference voltage register 840. The reference voltage generator 240 may be configured so that the second reference voltage register 840 is automatically reset to have the initial value of the digital reference voltage DVref when the target charge current D_I1 is set in the current register 850. Alternatively, the reference voltage generator 240 may be configured so that the current register 850 is automatically reset to have the target charge current D_I1 when the initial value of the digital reference voltage DVref is set in the second reference voltage register 840.

Alternatively, the reference voltage generator 240 may be configured so that the setting of the target charge current D_I1 in the current register 850 and the setting of the initial value of the digital reference voltage DVref in the second reference voltage register 840 are independently performed. Once the target current D_I1 has been set, the target current D_I1 is not changed before being reset. However, the digital reference voltage DVref may be changed for controlling the charge current I1.

Thus, when power is applied on the battery charger after the battery charger has been off, the digital reference voltage DVref is changed until the charge current I1 reaches the target charge current. Additionally, when the charge current I1 reaches the target charge current, the digital reference voltage DVref may be changed to prevent the charge current I1 from being changed.

The second DAC 860 converts the target charge current D_I1 to an analog voltage Vtarget. The second DAC 860 converts the analog target charge current D_I1 to the analog target voltage Vtarget by a ratio between the output voltage Vs and the charge current I1. The second comparator 810 compares the output voltage Vs of the current sensor 230 and the analog target voltage Vtarget, and such a comparison is digitized by the second ADC 820.

The second register updater 830 reduces the digital reference voltage DVref by one incremental step when the output voltage Vs is higher than the target voltage Vtarget. Alternatively, the second register updater 830 raises the digital reference voltage DVref by one incremental step when the target voltage Vtarget is higher than the output voltage Vs. Further, the second register updater 830 maintains the reference voltage DVref when the output voltage Vs is substantially the same as the target voltage Vtarget. The digital reference voltage DVref is converted to the analog reference voltage Vref by the third DAC 870 for the current source controller 220.

FIG. 9 is timing diagram of signals during operation of the battery charger of FIG. 2, according to an example embodiment of the present invention. Referring to FIGS. 2 and 9, the charge current I1 has a substantially constant value in the constant current mode. As the battery 260 is charged by the charge current I1, the charge node (i.e., battery terminal) voltage V1 increases.

When the battery terminal voltage V1 reaches the lower regulation voltage Vreg1, the constant current mode ends, and the constant voltage mode begins. In that case, the voltage level detector 253 indicates to the reference voltage generator 240 that the charge node voltage V1 has reached the lower regulation voltage Vreg1. As a result, the reference voltage generator 240 is deactivated such that the reference voltage Vref may be constantly maintained regardless of the magnitude of the charge current I1.

In the constant voltage charge mode, when the battery terminal voltage V1 increases, the third current I3 increases to decrease the second current I2. Thus, the charge current I1 gradually decreases as the battery terminal voltage V1 increases. When the charge node voltage V1 reaches a maximum regulation voltage Vreg2, the charge current I1 becomes zero such that the battery terminal voltage V1 does not exceed the maximum regulation voltage Vreg2.

In this manner, the charge current I1 for charging the battery 260 is precisely controlled and is maintained at the desired target level. Thus, the time required for charging the battery 260 may be predicted to a high degree of accuracy. In addition, the battery terminal voltage is limited to the maximum regulation voltage such that the battery 260 is not overcharged.

While the example embodiments of the present invention and their advantages have been described in detail, it should be understood that various changes, substitutions and alterations may be made herein without departing from the scope of the invention. The present invention is limited only as defined in the following claims and equivalents thereof.

What is claimed is:

1. A battery charger comprising:
a first current source for generating a first current for charging a battery in a first current path;
a second current source for generating a second current conducted to a feedback load in a second current path;
wherein the first and second current paths are separate with the first and second current sources forming a current mirror;
a current sensor for indicating a level of the first current;
a current source controller for adjusting the first and second currents by comparing a reference voltage with a load terminal voltage of the feedback load; and
a reference voltage generator for setting the reference voltage depending on the level of the first current such that the first current is maintained to be constant.

2. The battery charger of claim 1, wherein the current sensor includes:
a resistor with a measured current flowing there-through; and
an amplifier for amplifying a voltage across the resistor for generating an output signal that indicates the level of the first current.

3. The battery charger of claim 2, wherein the measured current is a sum of the first and second currents.

4. The battery charger of claim 2, wherein the measured current is the first current.

5. The battery charger of claim 2, wherein the measured current is the second current.

6. The battery charger of claim 2, wherein the reference voltage generator sets the reference voltage from comparing the output signal with a target value.

7. The battery charger of claim 6, wherein the reference voltage generator includes:
an analog-to-digital converter (ADC) for converting the output signal to a digital output signal;
a digital controller for generating a digital reference voltage by comparing the digital output signal with the target value; and
a digital-to-analog converter (DAC) for converting the digital reference voltage to the reference voltage.

8. The battery charger of claim 7, wherein the digital controller includes:
a first register for storing the target value;
a second register for storing the digital reference voltage;
a comparator for comparing the digital output signal with the target value; and
a register updater for updating the digital reference voltage in accordance with the comparison of the digital output signal and the target value.

9. The battery charger of claim 8, wherein the register updater reduces the digital reference voltage when the digital output signal is higher than the target value, raises the digital reference voltage when the digital output signal is lower than the target value, and maintains the digital reference voltage when the digital output signal is substantially the same as the target value.

10. The battery charger of claim 6, wherein the reference voltage generator comprises:
a first register for storing the target value;
a second register for storing the digital reference voltage;
a DAC (digital-to-analog converter) for converting the target value to an analog target value;
a comparator for comparing the output signal with the analog target value;
an ADC (analog-to-digital converter) for digitizing the comparison result of the output signal and the analog target value;
a register updater for updating the digital reference voltage in accordance with the digitized comparison result; and
another DAC (digital-to-analog converter) for converting the digital reference voltage in the second register to the reference voltage.

11. The battery charger of claim 10, wherein the register updater reduces the digital reference voltage when the digital output signal is higher than the target value, raises the digital reference voltage when the digital output signal is lower than the target value, and maintains the digital reference voltage when the digital output signal is substantially the same as the target value.

12. The battery charger of claim 1, further comprising:
a charge voltage regulator for limiting a battery terminal voltage to a maximum regulation voltage.

13. The battery charger of claim 12, wherein the charge voltage regulator includes:
a voltage level detector for detecting the battery terminal voltage; and
a third current source for generating a third current flowing to the feedback load depending on the battery terminal voltage.

14. The battery charge of claim 13, wherein the reference voltage generator is deactivated when the battery terminal voltage reaches a lower regulation voltage.

15. The battery charge of claim 14, wherein the third current source generates the third current that increases in proportion to the battery terminal voltage when the battery terminal voltage is greater than or equal to the lower regulation voltage such that the battery terminal voltage is limited to the maximum regulation voltage.

16. A method of charging a battery, comprising:
generating a first current for charging a battery in a first current path;
generating a second current conducted to a feedback load in a second current path;
wherein the first and second current paths are separate with the first and second currents being generated from a current mirror;
determining a level of the first current;
adjusting the first and second currents by comparing a reference voltage with a load terminal voltage of the feedback load; and
setting the reference voltage depending on the level of the first current such that the first current is maintained to be constant.

17. The method of claim 16, further comprising:
comparing the level of the first current with a target value; and
setting the reference voltage in accordance with the comparison of the level of the first current and the target value.

18. The method of claim 17, further comprising:
reducing the reference voltage when the level of the first current is higher than the target value;
raising the reference voltage by when the level of the first current is lower than the target value; and
maintaining the reference voltage when the level of the first current is substantially the same as the target value.

19. The method of claim 16, further comprising:
limiting a battery terminal voltage to a maximum regulation voltage.

20. The method of claim 19, further comprising:
detecting the battery terminal voltage; and
generating a third current to the feedback load depending on the battery terminal voltage.

21. The method of claim 20, further comprising:
increasing the third current in proportion to the battery terminal voltage when the battery terminal voltage is greater than or equal to a lower regulation voltage such that the battery terminal voltage is limited to the maximum regulation voltage.
